(19) United States
(12) Patent Application Publication
(10) Pub. No.: US 2013/0091763 A1
(43) Pub. Date: Apr. 18, 2013

(54) Processing for preparation of Boron Nanoparticles

(71) Applicants: Bernard ROTTNER, Marseille (FR); Stanislas PARTYKA, Clapiers (FR)

(72) Inventors: Bernard ROTTNER, Marseille (FR); Stanislas PARTYKA, Clapiers (FR)

(73) Assignee: ONECTRA, Marseille (FR)

(21) Appl. No.: 13/698,159

(22) PCT Filed: May 12, 2011
(86) PCT No.: PCT/FR2011/051067

§ 371 Date: Dec. 11, 2012

(30) Foreign Application Priority Data
May 18, 2010 (FR) 1053812
May 12, 2011 (FR) 1154135

(51) Int. Cl. C01B 35/02

(52) U.S. Cl. CPC C01B 35/023; Y10S 977/896; Y10S 977/957; Y10S 977/902; B82Y 40/00
USPC 44/504; 423/298; 427/372.2; 977/896; 977/957; 977/902

(57) ABSTRACT

The invention relates to a method for providing boron nanoparticles, characterised in that it comprises at least the following steps: synthesising a boron/lithium LiB intermetallic compound by reacting a mixture of boron and lithium in a reactor, preferably under a vacuum and temperature of 650° C.; transferring and hydrolysing the boron/lithium intermetallic compound in order to produce boron nanoparticles, by immersion in a bath containing water at ambient temperature, under a neutral gas atmosphere such as argon; and separating the boron nanoparticles, especially by tangential filtration, from the other compounds produced by the hydrolysis reaction. The invention also relates to the use of boron nanoparticles.

The present invention relates to a process for preparation of boron nanoparticles intended for apparatus for detecting neutrons or missile fuels, or any other application, and also relates to a process for depositing a solid layer of boron for such apparatus for detecting neutrons.

It can be used in apparatus for detecting neutrons, of the proportional gas counter or ionisation chamber type, comprising solid layers of boron intended for equipping systems for measuring neutrons.

More particularly, a technical field of the invention is that of detecting neutrons originating from one or more sources emitting neutrons.

The invention can also be used in missile propulsion systems. More particularly, a technical field of the invention is that of missile fuels.

The invention applies particularly, that is non-limiting, both to detecting neutrons originating from containers or drums of radioactive waste coming from power stations or nuclear facilities and also to the surveillance of fissile materials.

Thermal neutrons can be detected by nuclear reaction with isotopes having the following properties:
stable isotope (non-radioactive).
large effective cross-section of the neutron-isotope reaction (the effective cross-section is proportional to the probability of interaction of the neutron with the nucleus of the relevant isotope).
the neutron-isotope reaction must emit a charged particle such as a proton or a light nucleus, such as for example an alpha particle.

There are very few isotopes combining these conditions: helium 3 (³He), lithium 6 (⁶Li) and boron 10 (¹⁰B).

For yield and efficacy reasons it is conventional to employ systems for measuring neutrons using tubes filled with helium 3 (³He) as apparatus for detecting neutrons.

However, such tubes filled with helium 3 are rare and costly due to a global shortage of helium 3. In fact, helium 3 is generally produced by radioactive reduction of tritium, constituting a by-product from the purification of tritium. The main sources of tritium are thermonuclear arms stocks. Due to international agreements on limitation and non-proliferation of thermonuclear arms, manufacturers of apparatus for detecting neutrons are experiencing a current ongoing shortage of helium 3.

Given the shortage of helium 3, manufacturers of apparatus for detecting neutrons can resort to lithium 6 and boron 10.

Boron 10 is however preferable to lithium 6 because, on the one hand, its cross-section is larger (cross-section of 3837 barns for boron 10 compared to 940 barns for lithium 6, with an cross-section of 5327 barns for helium 3) by way of indication and, on the other hand, boron 10 is chemically stable in its elementary form under standard conditions, as opposed to lithium 6 which reacts spontaneously with water and air.

Reaction R1 enabling detection of neutrons with boron 10 is the following:

Neutron+¹⁰B→⁷Li+alpha(⁴He)+E [R1],

where E corresponds to the energy released during reaction R1; in around 94% of cases E is equal to 2.31 MeV, whereas in 6% of cases E is equal to 2.79 MeV instead of 2.31 MeV.

For final detection of neutrons, it is conventional to use detection apparatus of the proportional gas counter type having the following operating principle: the alpha particles and ⁷Li in the case of ¹⁰B coming from reaction R1 ionise gas contained in a cavity of the proportional gas counter and accordingly lose their respective energies, at the same time generating secondary electrons. In addition, an intense electron field is formed in this cavity by application of high voltage between an anode extending partly into this cavity and a cathode generally constituting the wall of the cavity. The radius of curvature of the anode is generally small, less than 100 μm, so as to produce an intense electric field with relatively low potential differences. The secondary electrons cause amplification in the gas with this electron field, resulting in an increase in the charge. These electrons are collected at the level of the anode and the ions are collected at the level of the enclosure delimiting this cavity, said enclosure forming a cathode and producing pulse signals in the anode. The detection apparatus measures the number of neutrons by counting the number of pulse signals.

Boron has already been utilised for detecting neutrons, even prior to the shortage of helium 3, and its use has returned since the shortage of helium 3.

For this application for detection of neutrons, boron is employed conventionally in gaseous form, especially in the form of boron tri-fluoride (BF₃), in proportional gas counters made in the form of tubes similar to tubes of helium 3 described hereinabove, except for the filling gas.

However, there are two main disadvantages to such apparatus for detection of neutrons of the proportional gas counter type filled with gaseous boron compound.

A first disadvantage is the high level of toxicity of boron tri-fluoride which causes risks in the event of puncturing or deterioration of the apparatus. To remedy this defect, it is common practice to enclose the tubes filled with gaseous boron tri-fluoride with a specific absorbent; not only does this not completely remove the risk of leakage, but also the presence of this absorbent increases costs and complicates the design of the measuring system.

Yield from apparatus for detection (detector) of neutrons is defined by the ratio of the number of detections to the number of incident neutrons on this apparatus, and the efficacy of a device for measuring waste or fissile materials (measuring system integrating one or more detectors) is defined by the ratio of the number of detections to the number of neutrons emitted by the object to be characterised. These two values, yield and efficacy, are of course connected, but they are generally different due especially to:
absorption of neutrons inside the object to be measured or in the materials between the object to be measured and the detection apparatus or the detection apparatuses;
internal surface of the detection cavity of the detection apparatus incompletely covered by detectors;
reflection of neutrons having passed through the detection apparatuses.

A second disadvantage of detection apparatuses of neutrons of the known type of gaseous boron compound proportional counter is the low yield of tubes filled with gaseous boron tri-fluoride. It is possible to rectify this defect, on the one hand by using boron tri-fluoride enriched with boron 10, at 90% or even more, and on the other hand by increasing the number of tubes relative to apparatus employing tubes filled with helium 3. However, enrichment in boron 10 does not regain the characteristics of a tube filled with helium 3 (a factor of around 3 is needed) and the tubes filled with gaseous boron tri-fluoride enriched in boron 10 are not available commercially.

The implementation of neutron detection apparatuses employing boron in solid form has also been proposed, especially in the form of solid deposits of boron onto the internal surfaces of a proportional gas counter.

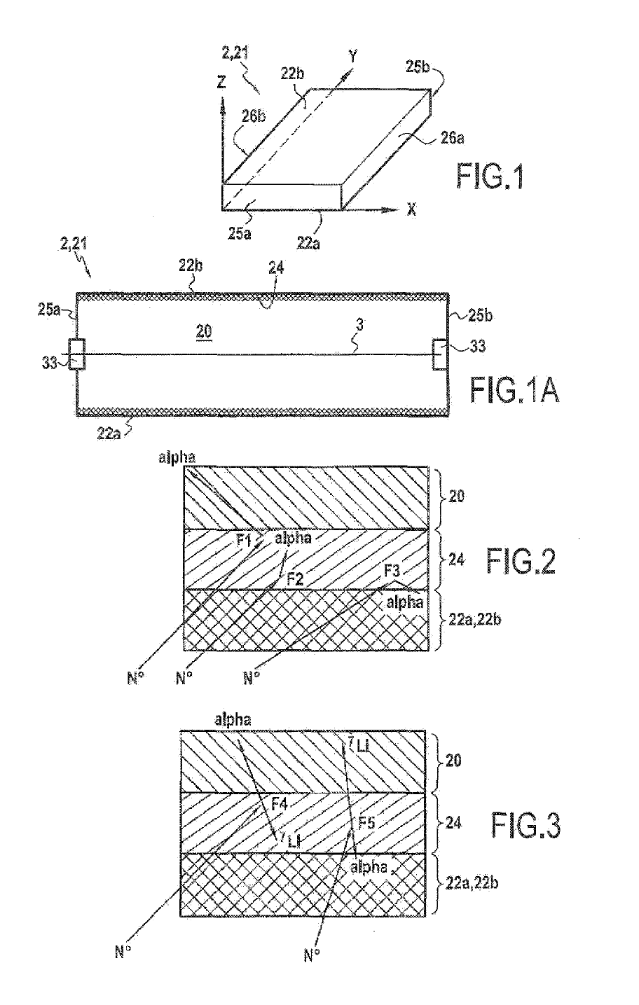

FIGS. 1 and 1A illustrate such known apparatus for detecting neutrons of the proportional gas counter type, comprising:
a metal enclosure 2 forming a cathode, said enclosure 2 delimiting a cavity filled with gas, said enclosure being constituted by a hollow parallelepiped body 21 comprising 2 main parallel walls 22a, 22b joined together at the level of their respective opposite edge by first transversal lateral walls 25a and 25b and second longitudinal lateral walls 26a and 26b. Said main walls 22a and 22b have 2 internal surfaces covered by a solid layer 24 of boron or a boron compound such as boron carbide or nitride, and
an anode 3 extending partly inside the enclosure and insulated electrically from the latter by pins 33.

The gas inside the enclosure is generally a gaseous argon (Ar)/carbon dioxide (CO₂) mixture in a 90/10 ratio and the apparatus generally comprises an open gas circuit for ensuring ongoing renewal of the gaseous mixture inside the enclosure.

The anode is conventionally a metal wire, such as tungsten, and is small in diameter, generally less than 100 μm. A voltage generator applies high voltage to the terminals of the anode, the value of which depends on the diameter of the anode, with voltage of around 500 V for example for a diameter of the order of 10 μm and voltage of around 1,000 V or more for a diameter of the order of 100 μm.

FIG. 2 illustrates three distinct emission phenomena of an alpha particle (⁴He) capable of featuring in apparatus for detecting neutrons of the proportional gas counter type, specifically:
a first phenomenon, illustrated by arrows F1, in which the neutron N passes through the hollow body 21 of the metal enclosure to react with boron 10 of the solid layer 24 of boron, in accordance with reaction R1 described hereinabove, and to emit an alpha particle sent in the direction of the cavity 20 at sufficient velocity to enter this cavity 20 and react with the gaseous mixture to allow the preferred detection as described previously;
a second phenomenon, illustrated by arrows F2, in which the neutron N passes through the hollow body 21 of the metal enclosure to react with boron 10 of the solid layer of boron 24, in accordance with reaction R1 described hereinabove, and emit an alpha particle sent in the direction of the cavity 20 at sufficient velocity to be able to pass through the layer 24 and reach the cavity 20 such that a neutron has been consumed in the layer 24 without as such being detected;
a third phenomenon, illustrated by arrows F3, in which the neutron N passes through the hollow body 21 of the metal enclosure to react with boron 10 of the solid layer of boron 24, in accordance with reaction R1 described hereinabove, and emit an alpha particle sent in the direction opposite the cavity 20 such that the particle fails to reach the cavity 20.

When the aim is to improve the efficacy of the measuring system, the unnecessary consumption of neutrons has to be limited, that is, for almost 100% of reactions R1 a charged particle must reach the gas to be detected. For this, not only the alpha particle (⁴He) emitted by reaction R1 has to be considered, but also the lithium-7 nucleus (⁷Li) to achieve this detection, since the two alpha particles and ⁷Li can ionise the gaseous mixture contained in the cavity 20, as described previously.

As illustrated in FIG. 3, according to the law of kinematics the alpha particles and ⁷Li are emitted against one another, making it theoretically possible to detect each neutron capture according to reaction R1:
either the alpha particle leaves in the right direction (direction of the cavity 20) and the lithium-7 nucleus (⁷Li) leaves in the direction opposite the cavity 20, as shown by arrows F4, and in this case it is the alpha particle which is detected;
or the lithium-7 nucleus (⁷Li) leaves in the right direction (direction of the cavity 20) and the alpha particle leaves in the direction opposite the cavity 105, as shown by arrows F5, and in this case it is the lithium-7 nucleus which is detected except if this core is emitted at insufficient velocity to be able to pass through the layer 24 and reach the cavity 20 (second equivalent phenomenon for the lithium-7 nucleus).

In theory, one alpha particle in two is emitted in the right direction and therefore a lithium-7 nucleus is emitted in the right direction such that, for 100 neutrons entering the proportional gas counter, reaction R1 engenders 50 alpha particles emitted into the cavity of the proportional gas counter and 50 lithium-7 nuclei emitted into this same cavity, without of course counting the particles absorbed in the thickness of the solid layer of boron due to lack of sufficient velocity (second phenomenon).

All proportional gas counters using solid layers of boron enable detection of a part of the lithium-7 nuclei, but if a detection yield of neutrons equal to 100% with reaction R1 is required, almost all the lithium-7 nuclei emitted to the gas need to be detected, in addition to the alpha particles.

The detection of lithium-7 nuclei in the gas of the proportional gas counter presupposes a solid layer of boron of very low surface density. So, surface density of the solid layer of boron (or boron compound) of around 0.2 mg/cm² detects 37% of lithium-7 nuclei produced during reaction R1, which is substantially equivalent to 75% of the lithium-7 nuclei emitted in the right direction, but in return exhibits a yield for detection of neutrons which is very low (6% for two solid layers of boron of surface density equal to 0.2 mg/cm²).

In general, the disadvantage of this type of detection apparatus is its low yield which does not exceed 10%. This maximal yield of 10% is a physical limit linked to the technique employed in this detection apparatus. It is not in fact possible to boost the yield of the apparatus by increasing the thickness of the solid layer of boron, because then the charged particles (alpha particles or lithium-7 nuclei) no longer reach the gas where they are detected, and neutrons are consumed uselessly (case of the second phenomenon).

Documents US 2005/0258373 and WO2004043372 describe detection apparatuses of neutrons for exceeding this physical yield limit of 10%, by using a bundle of small-diameter detection tubes (around 4 mm in diameter). Each detection tube constitutes a proportional gas counter with a central anode and a deposit of boron onto its internal surface, in this case a deposit of boron carbide. The yield from each detection tube is far less than 10%, but the yield of the bundle of tubes can exceed 50%. So these known apparatuses return good yields with solid thin layers of boron, due to this plurality of detection tubes.

A first aim is to provide a process for preparation of boron nanoparticles.

For making a solid layer of boron of constant thickness from boron powder, the granulometry of the powder should be less than the thickness of the solid layer of boron. A solid layer of boron having surface density 0.2 mg/cm² corresponds to a solid layer of boron of thickness of around 1 μm. It is therefore an advantage to make the solid layers of boron with such nanoparticles, given that these nanoparticles have nanometric dimensions under 0.8 μm, preferably less than 0.3 μm.

The invention also relates to a process for preparation of boron nanoparticles, particularly advantageous in that it produces boron nanoparticles of a granulometry less than 0.8 μm, preferably less than 0.3 μm, given that commercially available boron powders currently have a granulometry of around 30 μm, and that boron is particularly hard (just below diamond in the scale of hardness), and therefore difficult to crush.

In a particular embodiment of this process, step a) for preparation of the boron nanoparticles comprises the following steps:

a-1) synthesis of an intermetallic boron/lithium compound (LiB) by reaction of a mixture of boron and lithium in a reactor, preferably under vacuum and under heating of the order of 650° C. or even more, especially for 6 hours; and

a-2) transfer and hydrolysis of the intermetallic boron/lithium compound to produce boron nanoparticles, preferably by immersion in a bath containing water at ambient temperature, under atmosphere of neutral gas such as argon; and

a-3) separation of the boron nanoparticles, especially by filtration and/or centrifugation, with the other compounds originating from the hydrolysis reaction. The separation of nanoparticles is preferably conducted by tangential filtration. The solution obtained after hydrolysis is therefore filtered through a membrane or tubular mineral membranes, for example, of length of 25 mm, of internal diameter of 8 mm and of effective membrane surface of 40 cm². The membrane or membranes can be, for example, in alumina with a filtering layer of zirconium oxide of thickness 15 μm. The solution obtained after each filtration can be rediluted in distilled water to be refiltered. In this way, 2 to 4 filtration passes can be carried out, for example. Filtration helps to concentrate the NPB by a factor of around 20 without concentrating the lithine or lithium hydroxide (LiOH) which is a by-product of the synthesis of the NPB. Dilution of the concentrate containing the NPB in distilled water decreases the concentration of lithine by a factor of 20. Two filtration/dilution passes in distilled water decrease the concentration of lithine by a factor of 400, three passes by a factor of 8,000, four passes by a factor of 160,000, etc.

Preferably, according to another characteristic of the process:
in step a-1) the proportion of boron in the boron/lithium mixture introduced to said reactor is between 39 and 50%, and
in step a-2) bubbling of neutral gas, preferably argon, is carried out in the hydrolysis bath.

More particularly, in step a-1) the now synthesised intermetallic boron/lithium compound has an approximate chemical formula Li_{1.06}B, and is in the form of a sponge, the excess of lithium filling the pores of the sponge and protecting the alloy of the oxidation during opening of the reactor.

More particularly still, in step a-2), after the reactor is cooled it is opened and the alloy is poured into a bath of cold water, resulting in hydrolysis of the boron/lithium alloy for making nanoparticles of boron. This spontaneous and exothermic hydrolysis reaction with water is the following:

LixB+xH₂O→B+xLiOH+x/2H₂+traces of different boranes.

In step a-3) separation of the boron nanoparticles is performed to eliminate the collateral and unwanted species coming from reaction of the synthesis of boron nanoparticles such as LiOH, dispersants and boranes.

In a preferred embodiment, in step a-2) a bath containing water and dispersant are used advantageously to limit the growth of boron nanoparticles especially at a mass concentration of 50 to 1,000 ppm, resulting in boron nanoparticles whereof the large average dimension is between 250 and 800 nanometres.

An anionic dispersant marketed by COATEX under the reference GXCE or again a dispersant coupled with a non-ionic surfactant of type polypropylene-polyoxyethylene will be used more particularly.

The dispersant slightly reduces the size of the particles (factor 2), but the total absence of dispersant ends with production of particles of more acceptable size in sufficient quantity.

In a preferred embodiment, in step a-2) the hydrolysis bath is subjected to ultrasound to reduce the size of the nanoparticles. A density of ultrasonic power of over 100 W/L, preferably of the order of 350 W/L, reduces the size of the nanoparticles between 200 nm and 300 nm. A cooling system must then be added to evacuate the heat generated by the ultrasonic power. This cooling system is a system allowing a water bath or bubbling by neutral gas, for example.

In a preferred embodiment, in step a-2) vigorous bubbling of inert gas, preferably argon, is conducted in the hydrolysis bath. The advantages of this bubbling are multiple: limitation of the production of borane, evacuation of heat, homogenisation of the bath.

More particularly, on completion of step a-3), according to the power of the ultrasound injected, said boron nanoparticles have a size of 100 nm to 800 nm and said nanoparticles are porous particles, having a porosity of the order of 50% or of more than 30%.

Step a-3) can be followed by a mechanical crushing step to reduce the dimension of the NPB comprising at least:
a drying step of NPB by evaporation under vacuum;
a step of suspension of NPB in a non-oxygenated solvent;
a crushing step of NPB in the non-oxygenated solvent, for example, in a planetary crusher;
a drying step of NPB by evaporation under vacuum.

The non-oxygenated solvent can be cyclohexane, for example.

Because the nanoparticles are porous, their size in “equivalent solid boron” must be decreased in proportion to their porosity. Therefore for a porosity of 50% nanoparticles of 0.8 μm have an effective granulometry in equivalent solid boron of less than 0.4 μm.

Finally, the process can comprise a final control step of the quantity of boron nanoparticles deposited onto the support by differential weighing.

Another aim is to propose use of boron nanoparticles as adjuvant in fuel for missiles and mixed in a determined proportion with the combustion powder.

Another aim of the present invention is to provide a process for depositing a solid layer of boron from these nanoparticles onto a support for apparatus for detecting neutrons, which produces solid layers of boron with a controlled thickness and achieves the objectives of fixed yield for the apparatus.

The invention also relates to a process for deposit of a solid layer of boron onto a support preferably comprising said wall or surface for the preparation of said wall or surface covered in said solid boronated layer of apparatus for detecting neutrons, this process comprising the following steps:

a) preparation of boron nanoparticles of granulometry less than 0.8 μm, preferably less than 0.3 μm;

b) production of a boronated suspension by suspension of boron nanoparticles in a volatile solvent, preferably ethanol or acetone, and more preferably addition of a surfactant;

c) deposit or projection onto said support of a liquid film of said boronated suspension; and

d) drying of said boronated suspension, especially by heating.

The process for deposit of a layer of boron according to the invention is therefore useful for preparation of detection apparatus according to the invention and more particularly for preparation of said main wall or said intercalary wall of said detection apparatus according to the invention.

The aim of this process is to create solid layers of boron having a low and controlled thickness (or surface density), for the purpose of adjusting the detector to the selected optimum, between yield and neutron losses.

In step b, the preferred characteristic for the volatile solvent is simple evaporation, acetone being better from this point of view than ethanol, and the least volatile, though more inoffensive.

In step b, adding a surfactant especially in a proportion of less than 5% of the mass of boron ensures homogeneous depositing and improves adherence of the nanoparticles onto the surface of the support.

In steps c) and d), it is preferable to heat the support in advance, then to project the boronated suspension onto this hot support in such a way that it dries almost immediately without the boronated suspension having any time to flow sideways.

The novel process for production and depositing of said boron nanoparticles according to the invention gives a production yield of said boron nanoparticles (hereinbelow “NPB”) of at least 80%, or even at least 90%. After the inventors had performed numerous assays resulting in a disappointingly low yield (<30%), they were able to obtain yields of the order of 90% and more, due especially to the following characteristics:
Transfer of the synthesis reactor of step a-1) to that of hydrolysis of step a-2) under inert atmosphere, and conservation of this inert atmosphere in the top of the hydrolysis reactor, which atmosphere avoids parasite oxidations of the intermetallic compound LiB in contact with oxygen from air, and
Limitation to less than 50% of the mass proportion of lithium during Li—B reaction of step a-1). Surplus lithium (relative to LiB stoechiometry corresponding to lithium content of 39% in mass) is placed in the interstices of the entanglement of nanowires of LiB intermetallic compound, and protects the LiB from oxidation. The inventors discovered that an excess of Li is unfavourable to the production yield of NPB and that release of hydrogen during hydrolysis of the Li favours the production of boranes, to the detriment of that of NPB.
Bubbling by neutral gas such as argon during hydrolysis entrains hydrogen and avoids the formation of boranes.

Other known processes for depositing a solid layer of boron onto a support are feasible, such as:
deposit by cathodic pulverisation, described hereinbelow in the description,
deposit in vapour phase: vaporisation of boron 10, then condensation onto the support,
deposit by dissociation of boranes (gaseous compounds of boron and hydrogen, explosive).

The advantage of the novel process of deposit of nanoparticles according to the invention is the economising on raw materials (losses of under 20% against over 60%) the price of which is of the order of 50 [symbol] /g. For the set of measures with efficacy of 40% described in the example, if the losses of boron 10 are 80%, the cost of the boron 10 raw material will be 90,000 [symbol] , as against 23,000 [symbol] with the nanoparticles.

Another aim of the invention is use of the process in apparatus for detecting neutrons of the proportional gas counter type, or ionisation chamber, comprising:
an enclosure forming a cathode, said enclosure being filled with gas and comprising a hollow body comprising 2 main walls joined together by lateral walls, said 2 main walls having respectively two substantially parallel internal surfaces and each covered by a solid layer containing boron or a compound of boron hereinbelow called solid boronated layer, and a device forming an anode extending inside said enclosure;
said apparatus being characterised in that it also comprises at least one intercalary wall forming a cathode, fixed onto said lateral walls and extending inside said enclosure substantially parallel to said internal surfaces of the hollow body, the or each intercalary wall having two opposite surfaces opposite the respective internal surfaces of 2 said main walls of the hollow body and each covered by a solid layer containing boron or a compound of boron, and in that the device forming the anode has at least one part extending into a space between the intercalary wall and one of the internal surfaces of a first main wall of the hollow body and at least one other part extending into another space between the intercalary wall and the other internal surface of the second main wall of the hollow body.

With this type of apparatus comprising one or more intercalary walls each taking up two solid boronated layers inside the enclosure itself, it improves the yield of the apparatus by effectively multiplying the number of solid boronated layers and having said solid boronated layers of minimal thickness or of low surface densities, given by way of reminder that relatively thin solid boronated layers should be made to minimise losses.

According to another characteristic the solid boronated layers (containing boron or a compound of boron) exhibit surface density of between around 0.03 and around 0.5 mg/cm².

The thicker said solid boronated layer, the more considerable its neutron losses; given that neutron losses correspond to the proportion of captured, but not detected, incident neutrons, losses being estimated from the theoretical yield, which the quantity of boron 10 present would contribute.

Therefore, according to the present invention, to minimise losses it is advantageous to produce solid layers of boron which are thin, and to compensate this thinness by an increase in the number of boronated layers by an increase in the number of intercalary walls to guarantee the preferred yield.

Preferably, the solid boronated layers are made based on elementary boron. The apparatus gives a better yield when elementary boron is used, rather than a chemical compound such as boron carbide (B₄C), boron nitride (BN) or boric oxide (B₂O₃).

Advantageously, said solid boronated layers essentially comprise boron, in a proportion between 70% and 100%. More advantageously, said solid boronated layers essentially comprise boron 10, with preferably boron 10 content of between around 70% and 100%, to improve the yield of the apparatus.

Boron known as “enriched with boron 10” whereof the boron 10 content is greater than 99% is commercially available, for example.

More particularly, the solid boronated layers have a surface density of between around 0.03 and around 0.5 mg/cm², and said main walls and lateral walls, and/or the or each said intercalary wall are made from material having an atomic number under 20, especially plastic or metal material, said material being conductive material, preferably aluminium, or said solid boronated layer being covered by a layer of metal, preferably aluminium, more preferably of surface density less than 0.01 mg/cm².

The lateral walls can also be covered in boron to slightly boost yield.

The advantage of material having an atomic number preferably less than 20 is double: less sensitivity to gamma radiation and less sensitivity to cosmic radiation likely to tear away as many as ten neutrons from a heavy nucleus. And said metal layer improves conductivity, which in turn improves the performance of the detector with a high counting rate.

The device forming the anode can therefore comprise a single anode made from a single piece with anode parts joined to one another, which spans the entire enclosure. However, the limitations of electronics, or of applications with a high counting rate or which need localisation of neutrons, can impose dividing the cathode into several anodes, or even a multitude of distinct anodes, with these divided anodes capable of being in the form of strands or metal rods.

According to another original and advantageous characteristic of the invention, said solid boronated layers are made based on boron nanoparticles of granulometry under 800 nm.

More particularly, said particles are porous particles, having a porosity of around 50% or more than 30%.

Other characteristics and advantages of the present invention will emerge from the following detailed description of several exemplary non-limiting embodiments, given in reference to the attached figures, in which:

FIG. 1 is a schematic view of detection apparatus according to the invention presented schematically as a hollow parallelepiped plate,

FIG. 1A schematically illustrates a longitudinal section according to the plane yOz of known apparatus for detecting neutrons whereof the enclosure 2 is parallelepiped, as in FIG. 1,

FIG. 2, already mentioned, schematically illustrates three distinct phenomena for emitting an alpha particle which could appear in an apparatus for detecting neutrons of the proportional gas counter type,

FIG. 3, already mentioned, schematically illustrates the emission of alpha particles and ⁷Li opposite one another in apparatus for detecting neutrons of the proportional gas counter type,

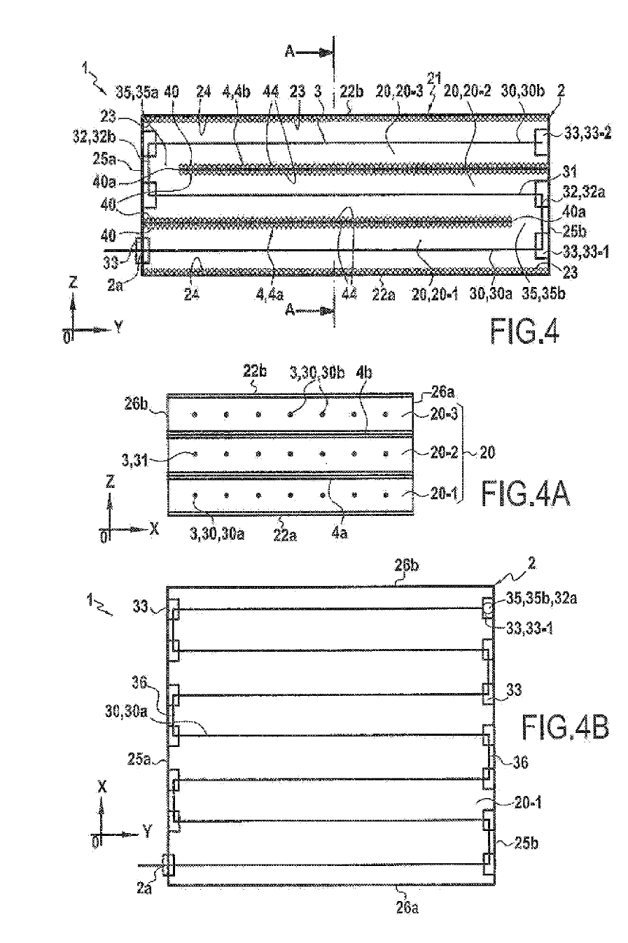

FIG. 4 schematically illustrates apparatus for detecting neutrons according to the invention, comprising a hollow parallelepiped plate as shown in FIG. 1 but viewed from a side wall 26a, that is, in the plane yOz. In the stricter sense, FIG. 4 is not a section in the plane yOz, as the point of entry 2a in the first stage 20-1 of the cavity 20 is positioned at a first angle between the lateral walls 25a and 26a, whereas the terminal 33-1 is away from 2a in the direction Ox, as shown in FIG. 4B,

FIG. 4A represents a sectional view according to AA in a perpendicular median plane xOz of the device of FIG. 4,

FIG. 4B represents a view in a plane xOy of the first stage 20-1 of the device of FIG. 4,

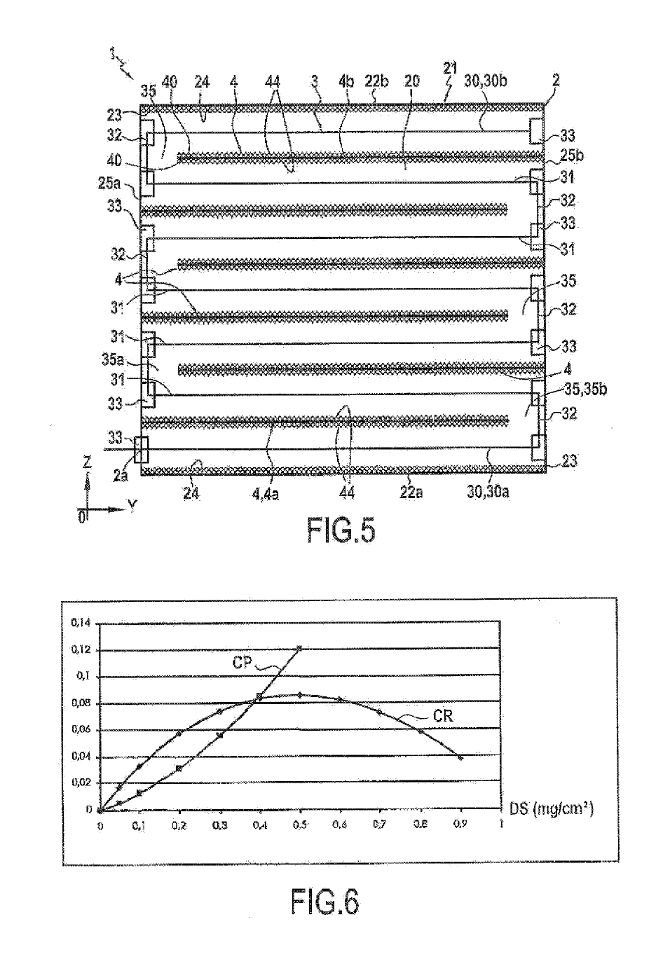

FIG. 5 schematically illustrates other apparatus for detecting neutrons in keeping with the invention and viewed from said second side wall 26a in the plane yOz of the parallelepiped apparatus of FIG. 1,

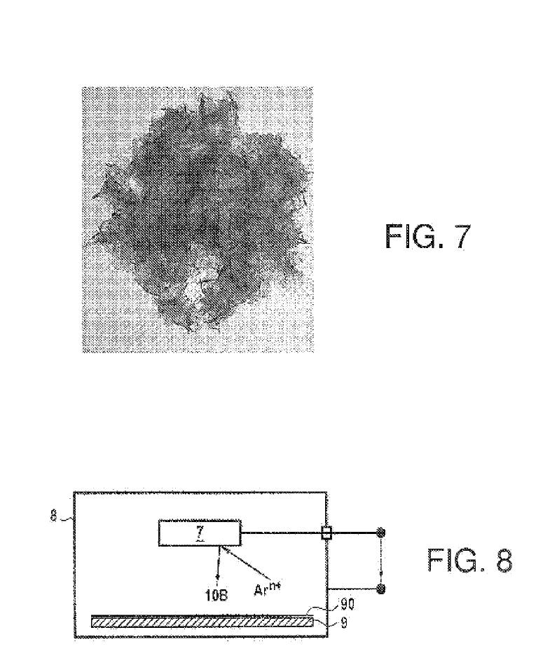

FIG. 7 represents a photograph of a nanoparticle of boron 60 according to the invention.

The novel process for providing nanoparticles of boron (NPB) and deposit onto an aluminium plate is described hereinbelow.

Elementary boron, of natural isotopy or enriched with boron 10, is available commercially in the form of powder having a granulometry of around 30 μm.

1. Usual Methods of Preparation of Nanoparticles of Boron:

Boranes B₂H₆, B₄H₁₀ are gaseous under ordinary pressure, B₅H₉, B₅H₁₁ and B₆H₁₀ are volatile liquids, B₁₀H₁₄ is solid. It should be noted that all boranes are flammable and the lightest of them including diborane, extremely toxic, react spontaneously with air, often explosively (green flash). The usual production methods of nanoparticles of boron utilise high-temperature decompositions of diborane B₂H₆, or of decaborane B₁₀H₁₄ vapour transported under argon in a quartz tube heated to 900° C.

Also, boron nanowires have been obtained by pulverisation (RF magnetron sputtering) of pure boron (99.9%).

2. Novel Method of Preparation of NPB from a Lithium-Boron Alloy:

2.1 Protocol for Preparation of the Alloy LiB:

An ingot, an alloy at 70% by weight of lithium is prepared from very pure lithium (99.94%) marketed by Cogema and from boron of 98% purity, granulometry 44 μm marketed by Alfa Aesar. The reaction is carried out in a stainless steel tube sealed under argon. The latter is heated in a horizontal oven, under rotary agitation. The rise in temperature from ambient to 650° C. takes place over four hours. Two exothermal reactions occur, one at 377° C. corresponding to the formation of LiB₅ compound, the other at 550° C. corresponding to the formation of the LiB (˜Li_{1.06}B) compound and to its instantaneous crystallisation in the form of an ingot with a refractory fibrous matrix of sponge type (which does not melt below 1,000° C.) and with a porous layer which traps the excess lithium. If the pure LiB compound (39% by weight of Li) is pyrophoric and cannot be handled in air, the ingot rich in lithium (70%) can be utilised without disadvantage beyond that of very moderately oxidising the protective lithium. On completion of these experiments, the inventors prepared ingots at 50% by weight of lithium, which are still relatively inert in air. Working in an argon atmosphere avoids oxidation of lithium and any possible explosion during transfer of the LiB from a tube to the aqueous solution of step 2.2 hereinbelow.

2.2 Protocol for Obtaining Nanoparticles of Boron:

Hydrolysis is performed in distilled water which contains an anionic dispersant COATEX® GXCE or a surfactant of polypropylene-polyoxyethylene type in very low quantity (50 to 1,000 ppm). The alloy LiB produces lithium hydroxide (LiOH) from elementary boron in amorphous form (dark brown), a reaction inevitably accompanied by release of hydrogen from a certain volume of borane. In contact with the lithiated aqueous solution of high pH, the major part of this borane is transformed into lithium borate, the rest diluting in the atmosphere and can be recognised by its highly unpleasant odour.

Hydrolysis of LiB must be performed under argon with vigorous permanent bubbling in the solution containing a dispersant. The first 26 experiments were conducted using the alloy at 70% by weight of lithium and 30% of boron, and gave a limited yield.

Only 20-28% of the initial boron is converted into nanoparticles, whereas the alloy at 50% of Li has a yield of at least 80%. Evacuation of the molecules of hydrogen which are released during hydrolysis reaction of LiB in water, by nitrogen or gaseous argon (violent bubbling) produced the efficacy of the conversion of LiB into NPB greater than 80% or even 90%.

In a preferred mode, hydrolysis is performed with injection of ultrasound into the hydrolysis bath to reduce the size of the nanoparticles. Ultrasonic power density of the order of 350 W/L reduces the size of the nanoparticles between 200 nm and 300 nm. A cooling system must then be added to evacuate the heat generated by the ultrasound power. This cooling system can be a system offering a water bath or bubbling by neutral gas.

In a preferred embodiment, during the hydrolysis step vigorous bubbling of inert gas, preferably argon, is carried out in the hydrolysis bath. The advantages of this bubbling are multiple: limitation of the production of borane, evacuation of heat, homogenisation of the bath.

2.3 Separation Protocol of NPB from the Basic Aqueous Solution:

The hydrolysis reaction lasts around 30 to 40 minutes with vigorous bubbling in argon. Once the reaction is finished, separation of NPB is done by tangential filtration.

The solution obtained after hydrolysis is therefore filtered through a tubular mineral membrane or membranes, for example, of length 25 mm, of inner diameter of 8 mm and of effective membrane surface of 40 cm². The membrane or membranes can be, for example, alumina with a filtering layer of zirconium oxide with a thickness of 15 μm. The solution obtained after each filtration can be refiltered after dilution in distilled water. So filtration can be performed 2 to 4 times, for example. Filtration allows the NPB to be concentrated by a factor of around 20, without concentrating the lithine or lithium hydroxide (LiOH) which is a by-product of the synthesis of the NPB. Dilution of the concentrate containing the NPB in distilled water allows the concentration of lithine to decrease by a factor of 20. Two filtration/dilution passes in distilled water allow the concentration of lithine to decrease by a factor of 400, three passes by a factor of 8,000, four passes by a factor of 160,000, etc.

2.4 Quantitative Evaluation of Reactional Efficacy is Conducted by Drying the NPB of the Suspension.

The NPB were dried in a heat chamber set to 300° C. Thermogravimetric analyses show in fact that the porosity of the NPB retains water, and that heating to 300° C. is necessary to evaporate it quasi-totally. After total evacuation of water, the NPB is weighed at ambient temperature and after equilibrium between the NPB and the ambient water vapour is restored. The resulting particles of NPB are illustrated in FIG. 7.

Following tangential filtration, the resulting NPB undergo a step of mechanical crushing to reduce their dimension. This crushing step comprises at least one drying step of the NPB by evaporation under vacuum, then a step of suspending the NPB in a non-oxygenated solvent and a crushing step of the NPB in the non-oxygenated solvent in a planetary crusher, for example, and finally a drying step of the NPB by evaporation under vacuum. The crushing step can reduce the size of the NPB by a factor of 2 to 3 in a non-limiting manner.

2.5 Chemical Analyses of the NPB

Chemical analyses performed on 5 different samples show that the quantity of boron in the mass of an NPB is at least 92%.

2.6 Deposit of NPB onto the Two Surfaces of 3 Aluminium Plates Intended to Constitute Intercalary Walls 4 of Detection Apparatus Described in Example 2, and Onto a Face of Each of the 2 Main Walls 22a and 22b of the Detection Apparatus 1 Described in Example 2.

Prior to deposit of particles of NPB onto the aluminium surface, the aluminium plates were degreased by acetone treatment and thereafter they were kept in pure ethanol.

Prior to deposit, the plates were dried at 80° C. The NPB were spread by hand using a pipette onto the plates still at a relatively high temperature. It should be noted that prior to deposit the NPB were sonicated (subjected to ultrasound) for 30 minutes. Once depositing is completed, and with evaporation of ethanol from the aluminium surface finished, the quantity of NPB was estimated by weighing at a surface density of 0.3 mg/cm² to 0.5 mg/cm².

3. Process for Depositing by Cathodic Pulverisation

A second process for depositing a solid layer of boron onto a support, said cathodic pulverisation, comprises the following steps in reference to FIG. 8:
a target 7, specifically a block of boron 10, is placed in a reactor 8 containing neutral gas such as argon;
a difference in potential between the target 7 and the walls of the reactor 8 in a rarefied atmosphere enabling creation of cold plasma is applied.

Under the effect of the electric field the positive plasma species (argon ions) are attracted by the cathode (target 7 of boron 10) and collide with the latter. Their impact causes pulverisation of atoms of the target in the form of neutral particles which condense onto the support 9, forming a solid layer of boron 10 on this support 9.

Example of use: apparatus for detecting neutrons

In reference to FIGS. 1 to 5 and 7, apparatus for detecting neutrons 1 of the proportional gas counter type comprises:
an enclosure 2 forming a cathode and internally delimiting a closed cavity 20 filled with gas, such as a gaseous argon (Ar)/carbon dioxide (CO₂) mixture in 90/10 ratio; and
a device forming an anode 3 extending partly inside said enclosure 2, in other words inside said cavity 20 such as described hereinbelow. The anode is a metal wire (typically tungsten) of small diameter (under 100 μm).

The enclosure 2 is made of material having an atomic number under 20, preferably metal material such as for example aluminium, and comprises:
a hollow body 21 formed by a parallelepiped enclosure 2 with 6 faces having two planes and parallel main walls 22a, 22b, extending according to a plane xOy, these main walls 22a 22b having respectively plane and parallel internal surfaces 23, each covered by a solid layer of boron 24 made according to the process described in Example 1;
two first lateral walls 25a and 25b connect the opposite edges 25 of the main walls 22a and 22b opposite the direction Oy, extending according to a plane xOz, and two second lateral walls 26a and 26b connect the opposite edges of the main walls 22a 22b in the direction Ox, said lateral walls 26a and 26b extending in planes yOz.

In FIGS. 4, 4A and 4B the apparatus for detecting neutrons 1 comprises one or more intercalary walls 4, 4a-4-b, forming a cathode, fixed onto the enclosure 2 and extending inside the enclosure 2, otherwise expressed, inside the cavity 20, parallel to the main walls 22a and 22b and to their internal surfaces 23 of the hollow body 21. The or each intercalary wall 4 has two plane and opposite surfaces 40 opposite the respective internal surfaces 23 of the main walls 22a and 22b of the hollow body 21, where each plane surface 40 is covered in a solid layer of boron 44.

In a variant not illustrated here, the device forming the anode 3 is divided into several distinct anodes to respond to limitation constraints of electronics and/or to applications with a high counting rate and/or to applications needing localisation of neutrons.

With respect to the solid layers of boron 24, 44, they respond to the following characteristics as described in Example 1:
surface density of between around 0.03 and around 0.5 mg/cm²;
enrichment of layers 24, 44 in boron 10, with preferably boron 10 content of between around 90 and 100%;
optional covering of layers 24, 44 with a layer of metal, preferably aluminium, of surface density less than 0.01 mg/cm²;
the layers 24, 44 are made based on elementary boron 10, and especially based on boron nanoparticles of granulometry less than 0.8 μm, preferably less than 0.3 μm,

FIG. 6 illustrates the variation of the yield (curve CR) and losses (curve CP) in a pair of solid layers of boron as a function of the surface density DS of this layer expressed in mg/cm². It is evident that the yield is maximal for a deposit of 0.5 mg/cm² but that losses increase with the surface density DS. Therefore, this density of 0.5 mg/cm² is not optimal, because the thicker the deposit the greater the neutron losses; the neutron losses correspond to the proportion of captured, but not detected, incident neutrons and these losses are estimated from the theoretical yield which the quantity of boron 10 present would contribute. As a consequence, the surface density of the layers 24, 44 is less than 0.5 mg/cm².

The apparatus 1 illustrated in FIG. 4, though with 4 pairs of layers instead of 3, is well adapted to equip a plutonium quantification system in a drum of radioactive waste whereof the volume is typically of the order of 200 litres.

The yield from apparatus 1 of FIG. 4 having 4 pairs of layers (8 layers) 24, 44, in which the layers 24, 44 have a surface density equal to 0.2 mg/cm², is 20% with 10% of losses; in other words out of 100 incident neutrons, 20 neutrons are detected, 10 neutrons are captured but not detected, and 70 neutrons pass through the apparatus 1.

Another example of use of nanoparticles obtained according to the process.

The nanoparticles such as prepared as in step a) can also be used as adjuvant to missile fuels. Boron is preferably natural boron to be used as adjuvant in fuel intended for the propulsion of missiles. A particular feature of boron is in fact having volume combustion heat greater than that of all the other elements and compounds: 130 MJ/L for 34 MJ/L to 39 MJ/L in conventional missile fuels. But this should be in extremely divided form so that combustion is efficacious. The size of the nanoparticles must be preferably less than or equal to 100 nm.

The exemplary embodiments described hereinabove have no limiting character and other improvements and details can be made and added to the apparatus according to the invention without as such departing from the scope of the invention where other forms of intercalary walls and/or enclosure and/or of device forming an anode can be produced, for example.

It must be evident for experts that the present invention allows embodiments in numerous other specific forms without departing from the field of application of the invention as claimed. Consequently, the present embodiments must be considered by way of illustration, but can be modified in the field defined by the scope of the attached claims, and the invention must not be limited to the details given hereinabove.

1. A process for preparation of boron nanoparticles, comprising at least the following steps:
a-1) synthesis of an intermetallic boron/lithium compound LiB by reaction of a mixture of boron and lithium in a reactor, preferably under vacuum and under heating of the order of 650° C.; and
a-2) transfer and hydrolysis of the intermetallic boron/lithium compound for making boron nanoparticles by immersion in a bath containing water at ambient temperature under atmosphere of neutral gas such as argon; and
a-3) separation of the boron nanoparticles, especially by filtration and/or centrifugation with the other compounds originating from the hydrolysis reaction.

2. The process as claimed in claim 1, wherein:
in step a-1) the proportion of boron in the boron/lithium mixture introduced into said reactor is between 39% and 50%.

3. The process as claimed in claim 1, wherein:
in step a-2) neutral gas, preferably argon, is bubbled in the hydrolysis bath.

4. The process as claimed in claim 1, wherein in step a-1), the hydrolysis bath is subjected to ultrasound.

5. The process as claimed in claim 1, wherein in step a-2) said bath contains water and a preferably anionic dispersant in a concentration appropriate for limiting growth of the nanoparticles.

6. The process as claimed in claim 1, wherein separation of the nanoparticles with the other compounds originating from the hydrolysis reaction is achieved by tangential filtration, preferably in 1 to 4 successive concentration steps.

7. The process as claimed in claim 1, wherein on completion of step a-3) said boron nanoparticles have a size of 100 nm to 800 nm and said nanoparticles are porous particles, having a porosity of the order of 50% or more than 30%.

8. The process as claimed in claim 1, wherein the step a-3) for separation of the NPB is followed by a mechanical crushing step for reducing the dimension of the NPB, comprising at least:
a drying step of the NPB by evaporation under vacuum;
a step for suspension of the NPB in a non-oxygenated solvent;
a crushing step of the NPB in the non-oxygenated solvent;
a drying step of the NPB by evaporation under vacuum.

9. Use of the boron nanoparticles prepared as claimed in claim 1 for deposit of a solid layer of boron onto a support constituted by a wall or surface (22a, 22b, 23, 4, 40) of a neutron detector for preparation of a wall or surface covered in a solid boronated layer for a neutron detector, comprising the following steps:
b) production of a boronated suspension by suspension of the boron nanoparticles in a volatile solvent, preferably ethanol or acetone, and more preferably addition of a surfactant ensuring an adhesion function for the nanoparticles;
c) deposit or projection onto said support (22a, 22b, 23, 4, 40) of a liquid film of said boronated suspension;
d) drying of said boronated suspension, especially by heating.

10. Use of the boron nanoparticles prepared as claimed in claim 1 as an adjuvant for missile fuel, further comprising the step of mixing in a determined proportion of boron nanoparticles with combustion powder.
